(19) United States
(12) Patent Application Publication
(10) Pub. No.: US 2025/0235836 A1
(43) Pub. Date: Jul. 24, 2025

(54) DEVICE AND METHOD FOR PREPARING MIXTURES

(71) Applicant: HS-TUMBLER GMBH, Quakenbrück (DE)

(72) Inventor: Bernhard HUKELMANN, Quakenbrück (DE)

(21) Appl. No.: 18/840,984

(22) PCT Filed: Feb. 27, 2023
(86) PCT No.: PCT/EP2023/054886

§ 371 Date: Oct. 25, 2024

(30) Foreign Application Priority Data
Feb. 25, 2022 (DE) 10 2022 201 990.3

(51) Int. Cl. B01F 31/50; B01F 23/40; B01F 23/43; B01F 23/50; B01F 23/53; B01F 31/00; B01F 35/214; B01F 35/221; B01F 35/53

(52) U.S. Cl. CPC B01F 31/50; B01F 23/405; B01F 23/43; B01F 23/511; B01F 23/53; B01F 23/565; B01F 31/70; B01F 35/214; B01F 35/22142; B01F 35/531; B01F 2215/0422; B01F 2215/0431; B01F 2215/0454; B01F 2215/0481

(57) ABSTRACT

A device for use as a mixing apparatus comprising a container having a cross-section of at least 5 mm diameter, the cross-section being spanned by a wall having protrusions projecting into the cross-section, the protrusions preferably being distributed over the entire wall, the container being driven to reciprocate along a path curve obtainable by superimposing the movement along at least two axes lying at an angle to each other and preferably in the plane of the cross-section of the container at different frequencies.

The invention relates to a device and a method, preferably carried out using the device, for producing a mixture which is preferably a powder mixture, optionally with a liquid component in the form of a suspension, or an emulsion, for example of at least two ingredients which preferably are not soluble in one another.

The device and the method have the advantage of converting ingredients in a container to a mixture, which is preferably a pure powder mixture, a suspension or an emulsion, without a mixing element which is movable relative to the container being attached or contained in the container, in particular without an agitator, so that the container is formed without a bearing for a movable mixing element.

The device is set up to carry out a mixing process that produces an intensive mixing of the ingredients in the container, e.g. a powder mixture, a suspension or an emulsion consisting of finely dispersed and evenly distributed solid particles and/or liquid ingredients, within a short period of time, e.g. within a maximum of 10 hours, a maximum of 8 hours, a maximum of 6 hours, a maximum of 4 hours, a maximum of 2 hours, a maximum of 1 hour, preferably a maximum of 5 minutes, a maximum of 3 minutes, a maximum of 120 seconds, a maximum of 100 seconds, a maximum of 60 seconds or a maximum of 30 seconds. In the case of liquid ingredients that are not soluble in each other, e.g. one lipophilic and one hydrophilic, an emulsion is produced that has such finely dispersed fat or oil droplets in water or water droplets in a fat phase that it can be stable without an emulsifier or surfactant.

WO 2015/114118 A1 describes the production of meat products by applying load to raw pieces of meat in a container which is driven along two axes in a forced reciprocating movement with a frequency of at least 0.5 Hz. The raw pieces of meat absorb e.g. aqueous or oily compositions or can stick together as a result of the load.

EP 3 620 067 A1 describes a mixing and kneading process for a polymer with a further ingredient, at least one of which is liquid, by reciprocating a container at at least 1 Hz along two axes at different frequencies.

The object of the invention is to provide a device and a method which can be carried out with it, by which ingredients which are not soluble in one another can be effectively converted into a homogeneous mixture, in particular to produce therefrom a homogeneously distributed powder mixture, a homogeneously distributed suspension or an emulsion. Preferably, the device and method should be suitable for producing a stable emulsion, which is a homogeneous mixture, from at least two liquids which are not soluble in one another, the resulting emulsion containing no emulsifier.

The invention archives the object by the features of the claims and provides in particular a device for use as a mixing apparatus and a method for producing a mixture with the device, wherein the device has a container with a cross-section of at least 5 mm diameter, the cross-section being spanned by a wall which preferably has protrusions arranged with spacings and projecting into the cross-section and having a height of at least 0.05 mm or at least 0.1 mm, e.g. from 0.05 to 0.5 or up to 0.2 or up to 0.1 mm, wherein the protrusions are preferably distributed over the entire wall and/or the spacing of the protrusions can be for example from 5 to 50 mm, wherein the wall can alternatively have a smooth surface, wherein the container is driven to a reciprocating movement along a trajectory curve which is obtainable by superimposing the movement along at least two axes at different frequencies, which axes are at an angle to each other and preferably lie in the plane of the cross-section of the container.

The container preferably has a round cross-section, or a cross-section which has at least 3, at least 4, at least 5, at least 6, at least 7 or at least 8 corners, e.g. a maximum of 20 corners in each case. The diameter of the container can, for example, be between 0.5 and 100 cm, e.g. 10 or 20 cm up to 80 or 60 cm in each case.

The cross-section of the container can be angular, round or oval. The cross-section, when reciprocating along trajectories, for example by moving back and forth along two axes which are at an angle to each other and lie in the plane of the cross-section of the container, results in a relative movement of the ingredients, which are filled into the container, against the container wall in a continuous movement. It is believed that the intensive and effective mixing of ingredients by the method is also due to the fact that the continuous movement completely captures the ingredients, e.g. without allowing ingredients to partially deposit or separate.

The protrusions projecting into the cross-section of the container may, for example, have a height from the wall of 1/30 to 1/1 or up to ½ or up to ⅕ or up to 1/10 of the diameter of the container, e.g. 1/20 to 1/1 or up to ½ of the diameter of the container, in particular a height of 0.1 to 20 mm, e.g. at least 2 mm, at least 3 mm, 4 mm or at least 5 mm, e.g. up to 18 mm or up to 15 mm in each case. The protrusions can have side surfaces perpendicular to the container wall, e.g. be cylindrical or cuboidal, and/or can have side surfaces that extend at an angle >95°, preferably >100° or >110° or >120° from the container wall, e.g. with an at least triangular cross-section and one or two side surfaces perpendicular to the container wall, conical or frustroconical. With a spacing from the container wall, the protrusions may have a second section, which has a larger cross-section than a first section connecting the container wall to the second section, e.g. a T-profile. Preferably, the protrusions have side surfaces whose profile extends from the wall in an arcuate manner, wherein the side surfaces connect to the wall in an arcuate manner.

The protrusions can be separated from each other or be connected to each other, e.g. as webs between which recesses, e.g. in the form of openings or blind holes, are arranged.

In general, the protrusions can be formed as webs, which are formed between recesses which webs extend into the container wall. Such webs can be produced, for example, by recesses made in the container wall, or by a sheet metal attached to the container wall, which has openings or blind holes, e.g. in each case as borings or oblong holes. The openings can extend parallel or perpendicular to the cross-section of the interior, or at an angle >0° to <90° to the cross-section of the interior. Optionally, additionally or alternatively, the openings can extend along the radial or at an angle of 10° to 45° to the radials that extend from the longitudinal axis of the cross-section spanned by the inner wall. Optionally, the openings have a constant cross-section or a cross-section that widens with increasing distance from the longitudinal axis. Optionally, the openings have a chamfer, preferably arcuate, to avoid sharp edges adjacent to the cross-section, or the openings are cylindrical or extend conically widening away from the longitudinal axis without a chamfer to form a sharp edge.

In an embodiment, the side surfaces of the protrusions merge continuously into the recesses formed between them.

In an alternative embodiment, the protrusions are arranged at a distance from the container wall, so that the side surfaces of the protrusions do not merge into the container wall or are not connected to the container wall. In this embodiment, the protrusions can be formed, for example, by a sheet metal that is spaced from the container wall and has openings, e.g. traversing round holes or traversing oblong holes. Such a sheet metal can, for example, be mounted at a distance of 1 to 30 mm from the container wall, preferably parallel to the container wall, e.g. be connected to the container wall by supports.

It has shown that protrusions that extend beyond the container wall into the cross-section of the container accelerate the mixing of ingredients upon reciprocating the container, e.g. in comparison with a cylindrical container with a flat wall.

According to the invention, mixing of the ingredients occurs by moving the container in a reciprocating motion along a trajectory curve with a frequency of at least 1 Hz along two axes, each with a different frequency, over a path along each axis of preferably at least 2.5 mm, at least 1 cm, at least 2 cm or at least 3 cm or at least 10 cm, e.g. up to 50 cm, up to 30 cm, up to 20 cm or, in the case of shorter paths, up to 10 cm.

The reciprocating motion of the container can, for example, extend over a path of at least 1.5 mm, preferably at least 3 mm, preferably at least 1 cm, preferably at least 2 cm or at least 5 cm, at least 10 cm or at least 15 cm, e.g. up to 50 cm, up to 30 cm or up to 20 cm. Further preferably, the reciprocating motion of the container is harmonious along a trajectory. The reciprocating motion of the container is non-linear and can be sinusoidal, loop-shaped or arcuate, preferably running along a trajectory curve, which is preferably in the plane or is two-dimensional. This is because, in general, a non-linear axis of movement, preferably a reciprocating movement along a trajectory curve, which may be a Lissajous figure or hypocycloid, promotes uniform and intensive mixing, even for components of the composition that have a similar or equal specific gravity. Each axis of movement can be linear in itself, so that the non-linear movement of the container is generated from the superposition of the movements along two axes of movement. Optionally, the reciprocating movement can also extend into a third dimension, perpendicular to the plane spanned by the first and second axes.

The container is driven for reciprocating movement along at least one trajectory curve which can be generated by superimposing the reciprocating movement along at least two axes which lie at an angle to one another, preferably two of the axes lying in the plane of the cross-section of the container, the reciprocating movement along each axis taking place at different frequencies and/or with a phase offset. The trajectory curve can be generated by superimposing the reciprocating movement along two or three axes at different frequencies and/or with phase offset and has a sequence of trajectory segments, at least one of which, preferably each, comprises or consists of exactly one complete reciprocating movement along the axis along which the reciprocating movement takes place at the lower frequency, the superimposed reciprocating movements comprising the higher frequency or of the same frequency, in each case optionally with phase offset, along the other axis or axes. Therein, lower frequency of the complete reciprocating movement forms the frequency of the sequence of trajectory segments. For each trajectory segment, a frequency ratio of the reciprocating movement along two axes of at maximum 1:20 or of at maximum 1:15 or of at maximum 1:10, of at maximum 1:4 or of at maximum 1:3 is preferred, more preferably between 1:1 and 1:2, even more preferably greater than 1:1 to 1:2 or up to 1:1.5, e.g. with a frequency ratio of 1:1.001 up to 1:2 or up to 1:1.5.

In the case of a trajectory curve that can be generated by superimposing the reciprocating motion along two axes at different frequencies and/or with a phase offset, the axes preferably lie in the plane of the cross-section of the container. In the case of a trajectory curve that is formed by superimposing the reciprocating movement along three axes, two of the axes preferably lie in the cross-sectional plane of the container and the third axis is at an angle to this cross-sectional plane. Therein, the lowest frequency of the complete reciprocating movement along one of the three axes forms the frequency of the sequence of trajectory segments. It is generally preferred that the linear axes of movement are at right angles to each other. In general, the trajectory curve does not include any rotation of the container around its own axis.

In general, the device is set up to drive the container along a trajectory curve which is formed by superimposing the reciprocating motion of at least two superimposed linear axes which are at an angle to one another, the reciprocating motion along the linear axes taking place at different frequencies and/or with a phase offset. The linear axes, along which the superimposed reciprocating movements take place at different frequencies and/or with phase offset, form the trajectory curve along which the reciprocating movement of the container takes place, for which the device is set up.

By moving the container along the trajectory curve, the device is set up to accelerate the mixture relative to the container, so that solids and/or liquids contained in the container are sheared by the acceleration against the container wall and by the movement along or against the container wall and are thereby intensively mixed.

Since the trajectory curve can be adjusted or predetermined by the different frequencies and/or the phase offset of the superimposed movements along the linear axes, the device is set up for the reciprocating movement of the container along the trajectory curve and for the relative movement of the solids and/or liquids and the mixture with respect to the container.

Generally preferably, the container is not rotationally driven and further preferably not or not completely rotatable, e.g. rotatable by a maximum of 30° or by a maximum of 20° or 10° about its central axis. Generally preferred, the container is driven exclusively for a reciprocating movement along a trajectory curve.

The path curve, adjustable or predetermined by the different frequencies and/or the phase offset of the superimposed movements along at least two linear axes, accelerates solids and/or liquids and the mixture of these relative to the container. The reciprocating movement of the container drives the solids and/or liquids and the mixture thereof to move against the inner wall of the container.

The trajectory curve can be used to determine the angle of incidence and angle of emergence of the solids and/or liquids and of the mixture of these against the container wall. In addition, the device is optionally set up to move the container along the trajectory curve with adjustable or predetermined acceleration and speed. In that the device is arranged for an adjustable or predetermined trajectory curve and/or an adjustable or predetermined acceleration and/or an adjustable or predetermined velocity along the trajectory curve of the reciprocating movement of the container, solids and/or liquids and the mixture thereof are driven with adjustable or predetermined acceleration and/or velocity relative to the container and allows a predetermined or continuous adaptation of the method to the solids and/or liquids and to the mixture thereof.

In general, a trajectory curve can be formed by at least two superimposed individual oscillations; preferably, a trajectory curve resembles the trajectory curve that can be generated by superimposing reciprocating movements along at least two linear axes of movement at different frequencies and/or by phase offset. A reciprocating movement along a trajectory curve that resembles the reciprocating movement along linear axes of movement that are superimposed on each other has different frequencies and/or a phase offset to each other. In general, a trajectory curve is therefore optionally not a circular path.

The difference in frequencies can, for example, be at least 0.01 Hz and/or 0.01% to 900%. The phase offset of the reciprocating movements along the linear axes can be, for example, from 0.01° to 180°, preferably 1 to 179° of 360°, corresponding to one complete reciprocating movement. In this case, 0.01 to 180° of a complete reciprocating movement of 360° is equal to 0.0028% to 50% of one complete reciprocating movement, 1 to 179° of 360° is equal to 0.28% to 49.7% of one complete reciprocating movement.

Therein linear axes of movement are, for example, perpendicular or at a different angle, e.g. 5° to 85° to each other, in particular in the plane of the cross-section of the container and/or perpendicular to a central axis of the container. Optionally, the trajectory curve contains at least one straight-line section, the end of which is, for example, an apex of the trajectory curve, at which the solids and/or liquids and the mixture thereof are accelerated away from the container wall or against the container wall.

For setting up different frequencies and/or a phase offset of the superimposed reciprocating movements along at least two linear movement axes, these reciprocating movements can be coupled together by a transmission or a link guide and driven by a motor. A transmission driven by a motor, which adjusts the reciprocating movement along the trajectory curve, can have a fixed transmission ratio between the superimposed movements along each axis, or an adjustable transmission ratio, e.g. a continuously or incrementally shiftable transmission. Optionally, the transmission can be slip-loaded, e.g. have a belt drive or be a friction gearbox.

The output speed of the transmission, which drives the reciprocating movement of the container, is preferably at least 1 Hz, more preferably at least 2.5 Hz, more preferably at least 5 Hz, more preferably at least 7 Hz, e.g. up to 50 Hz, up to 40 Hz, up to 30 Hz, up to 20 Hz or up to 10 Hz. Therein, the output speed of the transmission is equal to the frequency of the reciprocating movement.

Alternatively, the reciprocating motion along each of the linear axes of motion may be driven by a separate motor, wherein for the purposes of the invention the lower output speed is the frequency of the reciprocating motion and forms the frequency of the sequence of trajectory segments. In any embodiment, the speed of each drive motor may be controlled, fixed or variable over the duration of the process.

The device allows the trajectory curve to accelerate the solids and/or liquids and the mixture of these in a defined direction to a specific location on the inner wall of the container. Therein the geometry of the container and its inner wall can support the mixing process in conjunction with the trajectory curve, so that the trajectory curve can be adjusted depending on the shape and size of the container cross-section.

Optionally, the device is set up to change the trajectory curve of the reciprocating movement and/or the acceleration and/or speed of the reciprocating movement during the process, for example in a first phase to set the reciprocating movement along a first path curve and with a first acceleration and speed and to set the reciprocating movement in a subsequent second phase along a changed trajectory curve and/or changed acceleration and/or speed.

Further optionally the reciprocating movement is a linear reciprocating movement in a first phase and a reciprocating movement along merging trajectory curves in a second phase. The trajectory curve can, for example, be determined by a transmission that drives the movement of the container.

By adjusting the trajectory curve and acceleration of the reciprocating movement of the container, the device allows a predetermined or dynamically variable and directed acceleration of the contents as process material relative to the container.

In an embodiment, in which the container can be driven in a controlled manner in a first phase for a linear reciprocating movement, the device is set up to move solids and/or liquids and the mixture thereof in perpendicular against the container wall with a controllable acceleration which is significantly greater than the acceleration due to gravity and is therefore essentially independent of the acceleration due to gravity, e.g. with a maximum acceleration of at least 15 m/s², preferably 25 m/s², preferably at least 50 m/s² or at least 100 m/s² or at least 200 m/s² or at least 350 m/s², e.g. up to 500 m/s² in each case.

In general, the device can be set up to accelerate the container with a maximum acceleration of at least 20 m/s² or at least 100 m/s², e.g. at least 200 m/s², preferably up to 1000 m/s² or up to 300 m/s² along the trajectory segments, e.g. at an apex of the trajectory segments.

The container is preferably driven to a reciprocating movement with a maximum acceleration of at least 0.5 m/s² or at least 1 m/s² or at least 2 m/s², at least 3.5 m/s², preferably at least 60 m/s², more preferably at least 100 m/s², at least 150 m/s², at least 160 m/s², at least 200 m/s², e.g. in each case up to 300 m/s² or 450 m/s², up to 260 m/s² or up to 250 m/s² along each of two axes. Generally preferably, the container is driven in combination with the acceleration to an average speed of at least 0.5 m/s, preferably at least 2 m/s, more preferably at least 3.5 m/s, e.g. in each case up to 10 m/s or up to 20 m/s or up to 6 m/s, e.g. 3 to 4 m/s, in each case along one of the axes, preferably along each axis. The path of the movement along at least one axis, preferably along each axis, is e.g. 0.1 cm to 24 cm.

The container can, for example, be driven to a reciprocating movement extending along each axis over a distance of at least 1 mm or at least 2.5 mm, at least 1 cm, more preferably at least 2 cm or at least 5 cm, at least 10 cm or at least 15 cm, e.g. up to 100 cm, up to 50 cm, up to 30 cm or up to 20 cm in each case. Further preferably, the reciprocating movement of the container is harmonious. The reciprocating movement of the container can be linear in a first phase, generally the trajectory curve is non-linear and can, for example, be sinusoidal, loop-shaped or arcuate, preferably running along a so-called Lissajous figure or hypocycloid, which preferably lies in the plane, respectively is two-dimensional, optionally three-dimensional. Preferably, the reciprocating movement is linear in a first phase and in a second phase along at least two merging, non-linear trajectory segments, each containing at least one apex, to form a trajectory curve. This is because a non-linear trajectory curve, e.g. a movement along a trajectory curve whose trajectory segments each have at least one apex, generally promotes an impact of solids and/or liquids and the mixture of these, e.g. in perpendicular onto the container wall, as well as a movement along the container wall.

Preferably, the reciprocating movement comprises the reciprocating movement along a trajectory curve which comprises at least two, preferably at least three, more preferably at least four different trajectory segments, each of which has at least one apex and preferably merges into one another in a time sequence, preferably program-controlled. Each of the movement axes along which the movements are superimposed to form a trajectory curve can be linear or arcuate, so that the non-linear movement of the container along a sequence of trajectory segments is generated from the superimposition of the movements along two axes of movement. The apices and intermediate sections of a trajectory segment are determined by the frequency difference and/or the phase position of the superimposed reciprocating movements along at least two axes. In general, the device can be set up to change the frequency difference and/or the phase position during the reciprocating movement.

In general, the container wall is preferably the circumferentially closed wall of the container, which extends around a central axis and between respective terminal opposite cross-sections or lids attached thereto. The container has an optionally circular cross-section that extends around a central axis and is spanned by the container wall. Generally preferably, the terminal cross-sectional openings of the container are each covered by a lid, at least one of which optionally has a through opening.

It is generally preferred that at least one trajectory segment has an apex at which the direction of the trajectory segment changes by at least 90°, more preferably by at least 120°, even more preferably by at least 180°, e.g. within a maximum of 24.5%, a maximum of 24%, a maximum of 23%, a maximum of 22%, a maximum of 21%, a maximum of 20%, a maximum of 15%, or a maximum of 10%, more preferably a maximum of 5%, a maximum of 3% or a maximum of 2% or a maximum of 1% of the length of a trajectory segment. This is because an apex of the trajectory segment leads to a strong relative acceleration of the solids and/or liquids and the mixture of these against the container.

A preferred method of producing a mixture, within which the container optionally has a wall having a smooth inner surface spanning the cross-section, is a method of preparing a suspension of at least two powders in a liquid, preferably comprising a first step in which at least two powders are dry mixed to produce a dry powder mixture, a second step in which a solvent, aqueous solvent, organic solvent or a mixture thereof is mixed into the powder mixture to produce a suspension in the solvent, and an optional third step in which at least one adhesive is mixed into the suspension in the solvent. In each step, the mixing by reciprocating movement can have a duration of at maximum 50 s, preferably at maximum 40 s or at maximum 30 s, e.g. at the frequencies and accelerations of the reciprocating movement according to the invention. Optionally, all components of the mixture, in particular the powders, a solvent and adhesive can be mixed in exactly one step, or the dry powder mixture can first be prepared in a first step and in a second step adhesive in a mixture with or as a solution in solvent can be mixed into the dry powder mixture. Preferably at least one powder, preferably two powders are selected from a powdered metal (oxidation state zero), a metal oxide, e.g. a mixed alkali metal oxide, e.g. LiCoO₂, a conductive carbon compound, e.g. graphite, carbon black, fullerene, carbon nanotubes, graphene, and optionally a water-soluble alkali salt, e.g. a lithium salt. The solvent can be water, an organic solvent or a mixture of at least two of these, and the adhesive can be, for example, CMC (carboxymethyl cellulose) or SBR (styrene-butadiene rubber). Preferably, the powders are the components of an anode active material or a cathode active material or an electrolyte of a battery, in particular a lithium-ion battery, or an electrolyte for an electrical capacitor.

It has shown that the process for producing an electrolyte for a lithium-ion battery has the advantage of producing a better granularity of, for example, a maximum grain size of 20 μm if each of the three steps takes 30 s, instead of an Eirich intensive mixer with a duration of the mixing of 30 min each, which results in a granularity of a maximum grain size of 35 μm. Furthermore, it has shown that lithium-ion batteries whose electrolyte mixture was prepared by the method according to the invention in the mixing device, each step for mixing 30 s, exhibited a 10 to 30% higher battery capacity and also a lower tendency to lithium plating at the anode and/or a lower tendency to form Li dendrites than batteries prepared with a mixture of the same components but with mixing in the Eirich intensive mixer, each step for mixing 30 min. It is assumed that the mixing method according to the invention leads to a more homogeneous distribution of the powder components and to less destruction of the adhesive.

The control of the drive of the container is optionally controlled depending on the signal of a sensor, preferably an acoustic sensor, which picks up vibrations, in particular noises of the container during the reciprocating movement, in particular during the first and/or during the second phase. The acoustic sensor can, for example, be attached to the outer surface of the container or fixed at a distance from the container in a position past which the reciprocating movement of the container passes. Preferably, the acoustic sensor is fixed at a small distance, e.g. from 0.5 to 5 cm, from the apex of the reciprocating movement, e.g. fixed to a frame relative to which the container is moved along the trajectory curve. The acoustic sensor can be a vibration sensor, e.g. a microphone. In this embodiment, the control of the reciprocating movement can be set up, when the signal emitted by the acoustic sensor changes by a predetermined deviation within a predetermined time of the reciprocating movement, and/or when a predetermined signal emitted by the acoustic sensor is reached, to allow the reciprocating movement to run at a changed speed and/or with a changed phase offset and/or to control it from a linear movement into a trajectory curve, in particular to control it from a first phase to a second phase of the reciprocating movement. The sensor can also be an optical sensor attached to the container, e.g. a turbidity sensor.

Optionally, a device for generating electrical voltage is attached to the container, in particular a device with a magnet and a coil arranged to move relative to the magnet, which are set up to generate electrical voltage at relative movement to each other. This device is preferably connected to a transmitter attached to the container by means of an electrical cable in order to apply electrical voltage to the transmitter. Therein the transmitter is preferably connected to at least one of the sensors by means of a data line in order to receive sensor signals. The transmitter is set up, for example, to transmit received sensor signals. Furthermore, the sensor can be connected to the device for generating electrical voltage by means of an electrical cable. In this embodiment, the device is set up so that a sensor attached to the container and a transmitter can be energized by the device for generating electrical voltage as soon as the container is moved along the trajectory curve. Accordingly, the device may be set up without an electrical cable extending between a frame relative to which the container is moved, and the container.

Preferably, the container has a lower lid which can be opened or moved away from the inner volume in order to be able to open the inner volume for removing or dropping out or flowing the composition after the reciprocating movement. Further preferably, the container has an upper lid which is to be moved away from the inner volume in order to be able to open the inner volume for filling in the components of the initial composition. In this way, the container can be filled for a batchwise process after opening the upper lid, with subsequent closing of the inner volume by means of the upper lid, and after the reciprocating movement, opening of a lower lid for dropping out the mass. Such openable upper and lower lids can be formed by only one lid when the container is moved from a first position, in which the one lid is arranged above the inner volume, to a second position, in which this lid is arranged below the inner volume, and the opposite cross-sectional opening of the container is closed by a fixed lid.

Optionally, the container is temperature-controlled, in particular cooled. The container can be cooled by being arranged in a cooled housing or by having a double jacket through which a coolant can flow.

In general, the container can have a triangular or square, optionally polygonal cross-section, which can be closed at one end by a first lid and by a second lid arranged at the opposite end. The container can be arranged in such a way that one of the lids is arranged above the other lid, preferably with the container is arranged its cross-section parallel to the horizontal. Preferably, the container has an oval or round cross-section, the terminal openings of which are covered with lids, which may be domed or flat. Preferably, the container comprises a cylindrical inner volume. Generally, preferably in a container having an at least triangular cross-section or a polygonal cross-section, the movement can take place along a sequence of trajectory segments each having at least one apex, preferably each trajectory segment having a number of apices equal to the number of corners of the cross-section of the container. Alternatively or additionally, the number of apices of each trajectory segment can be equal to the number of corners of the cross-section of the container. The apices may, for example, comprise an angle that is at least twice as large, preferably at least three times as large, as the angle encompassed by one of the adjacent trajectory curves.

Each lid can extend in the plane of the cross-section of the container or be dome-shaped, preferably taper conically from the end cross-section of the container.

The movement along two axes, respectively the reciprocating movement, can be driven by a drive motor, wherein the different frequencies of the movements along the axes are achieved, for example, by means of a link guide, an eccentric drive and/or by means of a transmission. Alternatively, the reciprocating movement can be driven by two controlled drive motors. A drive motor can be a linear drive, e.g. an electric or hydraulic or pneumatic linear drive, or a rotary motor.

In order to generate a rolling movement, the container has, for example, an at least triangular or square, preferably pentagonal to octagonal, symmetrical or non-symmetrical cross-section, preferably an oval or round cross-section, and the reciprocating movement along the axes of movement takes place in a plane that runs, for example, approximately parallel up to a small angle, e.g. of max. 20° to this cross-section. Preferably, the plane runs parallel to the horizontal. Therein, the reciprocating movement can be adjusted to a rolling movement by changing the phase position of the movement along the axes. Accordingly, the frequency of the movement along each axis can optionally be changed over the duration of the reciprocating movement and/or the phase of the movement along the apices can be changed. Generally, preferably in the case of a container which has an at least triangular cross-section or a polygonal cross-section, the movement can take place along a sequence of trajectory segments which each have at least one apex, preferably each trajectory segment with a number of apices which is equal to the number of corners of the cross-section of the container. Alternatively or additionally, the number of apices of each trajectory segment can be equal to the number of corners of the cross-section of the container. The apices may, for example, comprise an angle that is at least twice as large, preferably at least three times as large, as the angle encompassed by one of the adjacent trajectory curves.

The device may have a supply conduit for ingredients at a terminal cross-sectional surface of the container, e.g. at one of the lids, which is an elastic conduit, e.g. a polymer hose. This is because the reciprocating movement can extend over short distances, e.g. 2 to 50 cm or up to 20 cm or up to 10 cm, so that an elastic conduit fixed to the container can follow this movement if this conduit is stationary fixed at a distance from the container.

Preferably, the protrusions each extend into the same spacing from the container wall, e.g. the protrusions can have end faces that are spaced apart from the container wall and lie in a common plane.

The container can have the protrusions formed in one piece with the container wall.

The container can be made of metal, e.g. stainless steel, titanium or cerium, plastic or ceramic. The device and the method have the advantage that there is no element such as an agitator within the container that can move relative to the container, so that no abrasion of an agitator can occur even with abrasive ingredients, e.g. metal powders or metal oxide powders.

It has shown that the container, in particular its inner wall, can consist of plastic or ceramic, e.g. in the production of mixtures with abrasive ingredients, e.g. with metal powders and/or metal oxide powders, optionally dry or with a liquid ingredient. This is because the movement of the container leads to little or no abrasion from its inner wall, or the abrasion is insignificant in terms of quantity and/or composition for the dry mixture or suspension produced. For example, in the production of suspensions containing metal powder or metal oxide powder, the abrasion of material from a plastic or ceramic container into the suspension can be insignificant for the subsequent use of the suspension.

The ingredients may be, for example, combinations of at least two powders, e.g. metal powder of oxidation state 0, metal oxide powder, plastic particles, glass frit, or combinations of at least two of these, in each case optionally with a liquid ingredient or exclusively dry powders, or consist of these. The optional liquid ingredient may be aqueous or organic, e.g. a solvent, a polymer, e.g. polyethylene glycol, a surfactant, inorganic, or a combination of at least two of these.

Preferably, the container can be sealed and vacuumed, e.g. by means of a sealable connector attached to the container or its lid, to which connector a vacuum source can be connected and which is sealed once the vacuum is reached.

The invention will now be described in more detail by means of examples with reference to the figures which show in

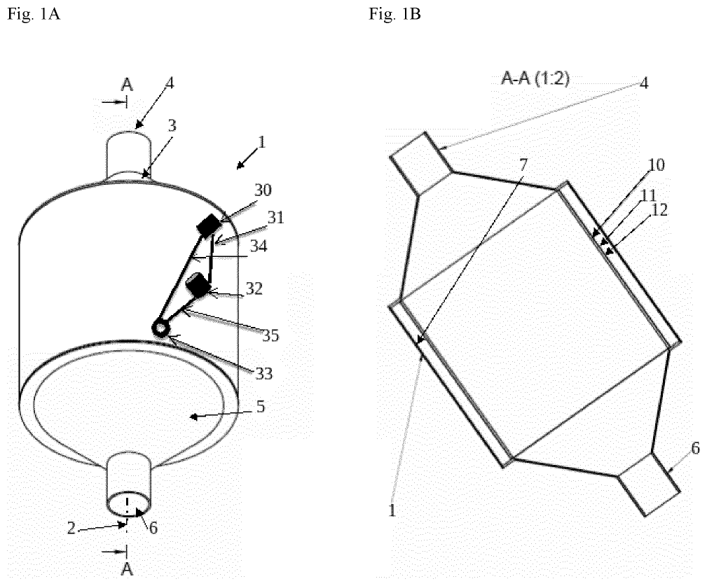

FIG. 1A an embodiment of the container in perspective view and, rotated, in FIG. 1B in longitudinal section,

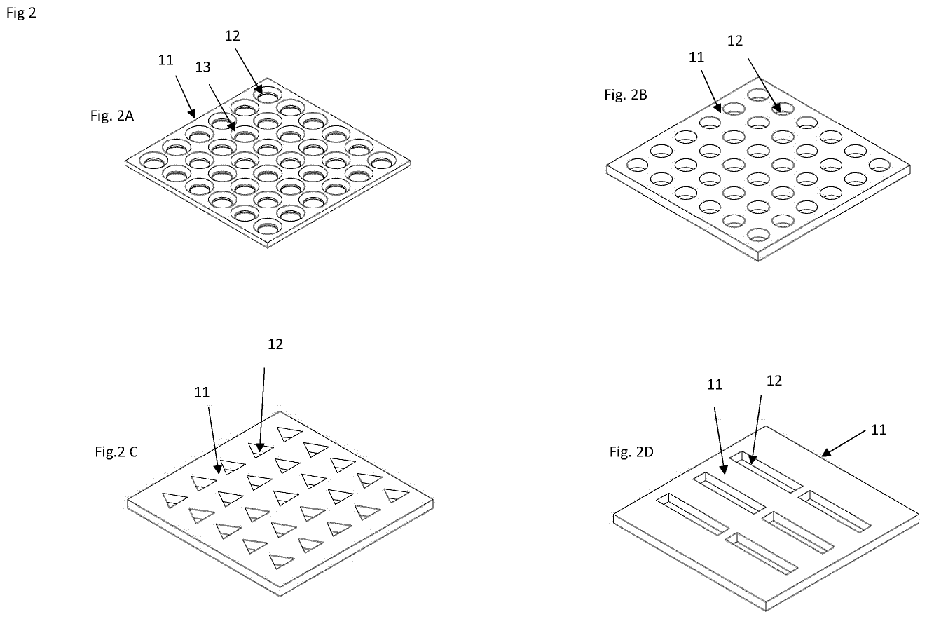

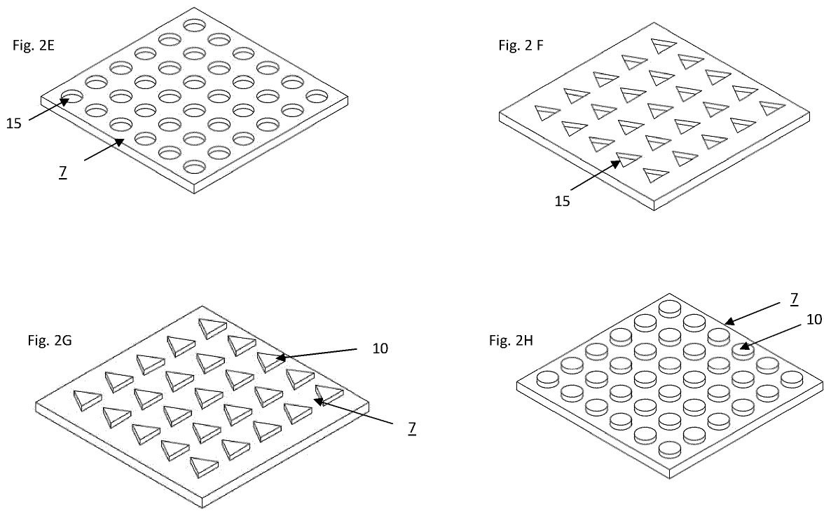

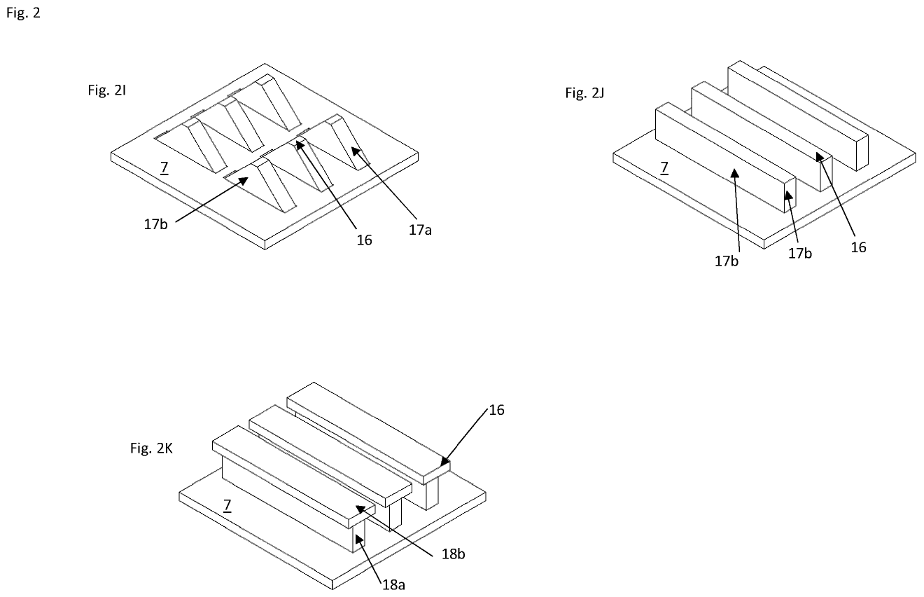

FIG. 2A to 2K embodiments of protrusions of the container wall.

In the figures, identical reference numerals denote elements with the same function.

FIG. 1A shows a container 1 which, as generally preferred, has a circular cross-section, with a first access opening 4 attached to a first lid 3 along the longitudinal axis 2 and a second access opening 6 attached to the opposite second lid 5 along the longitudinal axis 2. The first lid 3 and the second lid 5 each cover a terminal cross-section of the container 1. These lids 3, 5 run from the container 1 in the shape of a funnel to one of the access openings 4, 6. Alternatively, the container 1 can have only one access opening 4, 6, which is provided in one of the lids 3, 5, so that the filling and emptying of the container 1 can take place through only one common access opening 4, 6. Further alternatively, the lids 3, 5 can also be detachably mounted to the container 1.

A sensor 30, which is attached to the container 1, is connected by means of an electrical cable 31 to a device 32 attached to the container 1 for generating electrical voltage, which device has a magnet that can move relative to a coil. A transmitter 33 is connected to the sensor 30 by means of a data line 34 and to the device 32 for generating electrical voltage by means of an electrical cable 35.

The longitudinal section through the container 1 shown in FIG. 1B shows the protrusions 10 in an embodiment in which the protrusions 10 are formed as webs 11 between openings 12. In the embodiment shown here, the webs 11 are spaced apart from the container wall 7.

As an alternative or in addition to the protrusions 10 formed by the webs 11 spaced from the container wall 7, protrusions 10 can be attached directly to the container wall 7 and project into the container 1.

FIGS. 2A-K each show embodiments of protrusions 10 which are attached to the container wall 7 and project beyond it.

The embodiments shown in FIGS. 2A to 2D form interconnected protrusions 10 as webs 11 between openings 12. The webs 11 can rest directly on the container wall 7 or be attached at a spacing from the container wall 7, as shown in FIG. 2B, for example.

FIG. 2A shows webs 11 between circular borings 12, which form openings 12 whose opening facing the container 1 has a chamfer 13.

FIG. 2B shows webs 11 between cylindrical borings that form openings 12 whose openings facing the container 1 have sharp edges 14 of 90°.

FIG. 2C shows webs 11 between openings 12 with a triangular cross-section, whose openings facing the container 1 have sharp edges 14 of 90°.

FIG. 2D shows webs 11 between openings 12, which are designed as elongate holes whose openings facing the container 1 have sharp edges 14 of 90°.

FIGS. 2E and 2F show protrusions 10, which are formed as webs 11 between recesses 15, which are embossed or drilled into the container wall, e.g. as pocket holes or blind holes. FIG. 2E shows circular pocket holes as recesses 15, FIG. 2F triangular pocket holes.

FIGS. 2G to 2K show protrusions 10 separated from one another which protrude above the wall 7 of the container 1. The protrusions 10 may have end faces 16 which lie in a common plane which is spaced from the wall 7 and may lie substantially parallel to the wall 7. The end faces can, for example, be triangular (FIG. 2G) or round (FIG. 2H) or rectangular (FIG. 2J).

FIG. 2I shows protrusions 10 projecting over a container wall 7, the two opposite side surfaces 17a of which run towards an end face 16, while the intermediate side surfaces 17b run perpendicular to the container wall 7.

FIG. 2J shows protrusions 10 projecting above a container wall 7, the side walls 17b of which all extend perpendicular to the container wall 7 and the end faces 16 of which are rectangular and are spaced apart from the container wall 7 in a common plane.

FIG. 2K shows protrusions 10 projecting over a container wall 7, forming a T-profile, with a first section 18a spacing a second section 18b from the container wall 7. The second section 18b has a larger cross-section parallel to the container wall 7 than the first section 18a. In general, both sections can have a rectangular cross-section, with the second section extending symmetrically or optionally offset relative to the first section.

### EXAMPLE 1: PRODUCTION OF AQUEOUS CREAM

As an example of an emulsion optionally containing no emulsifier, cream was prepared from 30% by weight of oily substance, balance water, total 1 kg, in a generally cylindrical container, 4 l internal volume, diameter approx. 20 cm, the wall of which had protrusions projecting into the container. The protrusions were formed by webs consisting of a cylindrical sheet metal of 2 mm thickness with borings of 5 mm diameter in it. These protrusions formed by webs extended over the entire container wall, the terminal cross-sections were reversibly closed by flat lids.

The container was moved along two axes perpendicular to each other, which were in the cross-sectional plane of the container or perpendicular to its longitudinal axis, along one axis over a path of at least 10 cm at a frequency of the reciprocating movement of 7.1 Hz, along the other axis over a path of also at least 10 cm at a frequency of the reciprocating movement of 5.95 Hz. After a duration of 20 to 300 s, preferably only 30 s, of movement, the resulting mass was assessed as homogeneous and, after spreading on a glass, free of droplets visible to the eye. The mass retained this homogeneity when stored for at least 3 days at room temperature.

### EXAMPLE 2: PRODUCTION OF PASTE WITH METAL POWDERS

As an example of a suspension, at least two different metal powders, each with a grain size of 5 to 120 μm, were placed in a container with a volume of 500 ml as liquid sufficient to produce a paste.

A container made of PEEK as plastic or a container made of ceramic was used, which moved over a path of 6 cm along two axes at a frequency of 7.1 along one axis and 5.95 Hz along the other axis, both perpendicular to the longitudinal central axis of the container, in a 90° phase position. The container was round with a diameter of 18 cm and a height of 16 cm.

The container had a bottom and its upper opening was closed with a lid and the inside of the container was vacuumed through a connector in the lid.

After a duration of 5 minutes of reciprocating motion, a paste was produced in which the different metal powders were evenly distributed. No gas bubbles were found at visual inspection.

Alternatively, for an anode active material, 90 wt. % graphite and 5 wt. % nanomicroscopic carbon as conductive carbon black were mixed for 30 s in a mixing device according to the invention in a first step with a reciprocating motion at a frequency of 7 Hz, a path along a first axis of 5 cm and along a second axis perpendicular thereto of 5 cm along a Lissajous figure, subsequently in a second step water was added as solvent and mixed under the same conditions for 30 s, and subsequently thereto in a third step 3 wt. % CMC and 2 wt. % SBR were added and mixed again under the same conditions for 30 s, wherein in each case wt. % are of the total dry mass.

For a cathode active material, 90 wt. % LiCoO₂, 5 wt. % nanomicroscopic carbon was mixed in under the same conditions in a first step, water was mixed in as a solvent in a second step, and 3 wt. % CMC and 2 wt. % SBR were mixed in in a third step.

A lithium-ion battery produced with this anode active material and this cathode active material had a 10 to 30% higher electrical capacity and a significantly lower tendency to Li-dendrite formation than a battery whose anode active material and cathode active material were produced from the same starting materials but by mixing for 30 min for each step in the Eirich intensive mixer (has a rotating mixing element that is arranged eccentrically in a rotating mixing container).

Reference sign:

1 container
2 longitudinal axis
3 first lid
4 first access opening
5 second lid
6 second access opening
7 container wall
10 protrusion
11 web
12 recess as an opening
13 chamfer
14 sharp edge
15 recess as blind hole
16 end face of protrusion
17a tapered side surface
17b side surface perpendicular to the container wall
18a first section of protrusion
18b second section of protrusion
30 sensor
31 electrical cable
32 device for generating electrical voltage
33 transmitter
34 data line
35 electrical cable

1. A method for the production of a mixture comprising the steps of:
providing a container which does not contain a mixing element movable relative to the container, with a cross-section which is spanned by a wall,
filling at least two ingredients into the container,
moving the container reciprocating along a trajectory curve which comprises a sequence of trajectory segments which can be generated by superimposing the reciprocating movement along at least two axes with different frequencies and/or with a phase offset and which each comprise exactly one complete reciprocating movement along the axis along which the reciprocating movement takes place with the lower frequency and each have at least one apex in which the direction changes by at least 90° within a maximum of 24.5% of the length of a trajectory segment.

2. The method according to claim 1, wherein the wall comprises protrusions of a height of 0.01 to 0.5 mm arranged at a spacing of 10 to 30 mm and projecting into the cross-section.

3. The method according to claim 1, wherein the ingredients comprise a liquid ingredient and at least one metal powder and/or metal oxide powder and wherein the container is made of plastic or ceramic.

4. The method according to claim 3, comprising a first step of at least two powders being dry-mixed to produce a dry powder mixture, a second step comprising at least one solvent being mixed into the powder mixture to produce a suspension in the solvent, and a third step comprising at least one adhesive being mixed into the suspension in the solvent, wherein each step the mixing has a duration of at most 50 s.

5. The method according to claim 1, wherein the ingredients are exclusively liquid ingredients.

6. The method according to claim 1, wherein the trajectory segments have at least one apex in which they change their direction by at least 120° within a maximum of 10% of the length of a trajectory segment.

7. The method according to claim 1, comprising vacuuming the container is vacuumed after filling in the ingredients and prior to the moving.

8. The method according to claim 1, wherein the frequencies and/or the phase offset are changed during the reciprocating movement.

9. The method according to claim 2, wherein the protrusions are formed by webs which enclose recesses between them.

10. The method according to claim 9, wherein the webs have openings as recesses and that the webs are arranged at a spacing from the wall.

11. The method according to claim 2, wherein the protrusions have a height of 1/20 to 1/10 of a mean diameter of the container.

12. (canceled)

13. (canceled)

14. The method according to claim 1, wherein the difference in frequencies is at least 0.01 Hz and 0.01% to 900% and the phase offset is 0.0028% to 50% of the length of a trajectory segment.

15. The method according to claim 14, wherein the trajectory curve has at least one trajectory segment which comprises a rectilinear section.

16. The device according to claim 17, wherein the driver comprises a transmission which is a belt drive driven by exactly one motor or is a friction gear driven by exactly one motor.

17. A device for the production of a mixture, comprising a container having no mixing element movable relative to the container, the container comprising a cross-section spanned by a container wall, the container wall comprising protrusions that project beyond the container wall by at least 0.05 to 20 mm, the device comprising a driver configured to drive the container to a reciprocating movement along a trajectory curve, the trajectory curve comprising a sequence of trajectory segments which can be generated by superimposing the reciprocating movement along at least two axes with different frequencies and/or with a phase offset and which each comprise exactly one complete reciprocating movement along the axis along which the reciprocating movement takes place with the lower frequency and each having at least one apex in which the direction changes by at least 90° within a maximum of 24.5% of the length of a trajectory segment

18. The device according to claim 17, wherein the protrusions are formed by webs between which recesses are arranged as openings or blind holes.

19. The device according to claim 18, wherein the protrusions are separate from one another and project beyond the container wall to a common spacing from the container wall.

20. The device according to claim 17, wherein the container wall or the entire container is made of plastic or ceramic.

21. The device according to claim 18, wherein the webs are formed by a sheet metal which is attached with a spacing from the container wall and has openings.

22. The device according to claim 17, comprising a sensor connected to a controller configured to control the frequency of the reciprocating movement and/or the acceleration of the container during the reciprocating movement depending on the signal of the sensor, a device attached to the container comprising a magnet and a coil arranged movably relative to the magnet, which are arranged to generate electrical voltage when moving relative to one another and are connected by an electrical cable to a transmitter attached to the container.

23. The device according to claim 22, wherein the sensor is an acoustic sensor attached to the container or is fixed at a distance from an inflection point of the trajectory curve on a frame on which the container is guided for reciprocating movement.

24. The device according to claim 23, wherein the sensor is attached to the container and is connected to the transmitter and configured to transmit sensor signals via the transmitter.
